(19) United States
(12) Patent Application Publication
(10) Pub. No.: US 2012/0088053 A1
(43) Pub. Date: Apr. 12, 2012

(54) Release Sheet and Pressure-Sensitive Adhesive Article

(75) Inventors: Sou Miyata, Matsudo-city (JP); Takuo Nishida, Saitama-city (JP); Toshio Sugizaki, Yokohama-city (JP)

(73) Assignee: Lintec Corporation

(21) Appl. No.: 13/331,161

(22) Filed: Dec. 20, 2011

Related U.S. Application Data
(62) Division of application No. 12/441,435, filed on Mar. 16, 2009.

(30) Foreign Application Priority Data
Sep. 26, 2006 (JP) JP2006-261548

(51) Int. Cl. B32B 7/06; C09J 7/02

(52) U.S. Cl. 428/41.3

(57) ABSTRACT

Disclosed herein is a release sheet including: a base material; and a release agent layer provided on the base material, wherein the release agent layer is formed by curing a material mainly constituted of a diene-based polymer and contains substantially no silicone compound, and wherein Mooney viscosity (ML₁₊₄ (100° C.)) of the diene-based polymer before curing which is measured according to JIS K6300 at a temperature of 100° C. is in the range of 40 to 70. It is preferred that the material before curing is mainly constituted of one or two or more diene-based polymers having a cis-1,4 bond content of 90 to 99%.

### RELATED APPLICATIONS

This application is a divisional of prior application Ser. No. 12/441,435 filed Mar. 16, 2009, which claims the benefit of Japanese Appln. No. JP2006-261548 filed Sep. 26, 2006. The entire contents of each of these identified documents are hereby incorporated by reference.

### FIELD OF THE INVENTION

The present invention relates to a release sheet and a pressure-sensitive adhesive article (a pressure-sensitive adhesive sheet with the release sheet).

### BACKGROUND ART

Electric components such as relays, various switches, connectors, motors, and hard disk drives are widely used in various products.

In these electric components, pressure-sensitive adhesive sheets are attached for various purposes such as temporal tacking of parts during assembly and indication of the contents.

Such a pressure-sensitive adhesive sheet is generally composed of a pressure-sensitive adhesive sheet base and a pressure-sensitive adhesive layer, and it is being kept in a state adhering to a release sheet until it is attached to an electric component for use.

On a surface of the release sheet (i.e., on the surface to be attached to the pressure-sensitive adhesive layer), a release agent layer is provided for improving releasability. Conventionally, a silicone resin has been used as a constituent material of the release agent layer (see, for example, JP-A-6-336574).

However, it is known that when such a release sheet is attached to a pressure-sensitive adhesive sheet, a silicone compound such as a low-molecular weight silicone resin, siloxane, silicone oil, or the like contained in the release sheet (release agent layer) is transferred to the pressure-sensitive adhesive layer of the pressure-sensitive adhesive sheet. Further, normally, the release sheet is wound up in a rolled form after the production thereof, and in this state, the back surface of the release sheet is in contact with the release agent layer thereof so that the silicone compound contained in the release agent layer is transferred to the back surface of the release sheet. In this regard, it is also known that the silicone compound transferred to the back surface of the release sheet is re-transferred to the surface of a pressure-sensitive adhesive sheet when a pressure-sensitive adhesive article (which is composed of a pressure-sensitive adhesive sheet and a release sheet attached thereto) is wound up in a rolled form in manufacturing the pressure-sensitive adhesive article. Therefore, in a case where the pressure-sensitive adhesive sheet, to which such a release sheet has adhered, is attached to an electric component, the silicone compound transferred to the pressure-sensitive adhesive layer or the surface of the pressure-sensitive adhesive sheet gradually vaporizes. In this regard, it is known that the vaporized silicone compound is deposited on, for example, a surface of an electric contact portion of the electric component due to electric arc or the like generated near the electric contact portion so that a minute silicone compound layer is formed.

If such a silicone compound is deposited on a surface of an electric contact portion, there is a case where electric conductivity becomes poor.

Particularly, in a case where such a pressure-sensitive adhesive sheet is attached to a hard disk drive, the silicone compound transferred to a pressure-sensitive adhesive layer or a surface of the pressure-sensitive adhesive sheet gradually vaporizes and is then deposited on a magnetic head, a disk surface, or the like. Further, there is a possibility that deposition of such a minute silicone compound gives rise to adverse effects on reading and writing of data from and to a disk of the hard disk drive.

In order to solve the above problems, attempts to develop a non-silicone-based release agent containing no silicone compound have been made (see, for example, JP-A-2004-162048).

However, a release sheet using such a non-silicone-based release agent tends to require a higher release force when the release sheet is peeled off at high speed than at low speed.

Particularly, a pressure-sensitive adhesive article using such a release sheet having the dependence of release force on peel rate involves the following problems. For example, in a case where a pressure-sensitive adhesive sheet of such a pressure-sensitive adhesive article has an edge part and a label part formed by die cutting or the like and the edge part is peeled off and removed from the release sheet before the label part is peeled off from the release sheet and attached to an adherend, a high release force is required to peel off and remove the edge part from the release sheet at high speed. This makes it impossible to peel off and remove the edge part from the release sheet at high speed, thereby causing a problem that productivity is lowered. In addition, a high release force is also required to peel off the label part from the release sheet at high speed, and therefore it is difficult to use a labeling machine or the like which is capable of attaching the label part to an adherend at high speed.

### SUMMARY OF THE INVENTION

It is therefore an object of the present invention to provide a release sheet which can sufficiently suppress adverse effects on electric components and the like and which has a small dependence of release force on peel rate, and a pressure-sensitive adhesive article having such a release sheet.

In order to achieve the above object, the present invention is directed to a release sheet including: a base material; and a release agent layer provided on the base material, wherein the release agent layer is formed by curing a material mainly constituted of a diene-based polymer, and the release agent layer contains substantially no silicone compound, and wherein Mooney viscosity (ML₁₊₄ (100° C.)) of the diene-based polymer before curing which is measured according to JIS K6300 at a temperature of 100° C. is in the range of 40 to 70.

Such a release sheet can sufficiently suppress adverse effects on electric components and the like, and has a small dependence of release force on peel rate.

In the release sheet according to the present invention, it is preferred that the material before curing is mainly constituted of one or two or more diene-based polymers having a cis-1,4 bond content of 90 to 99%.

Further, in the release sheet according to the present invention, it is also preferred that the diene-based polymer before curing has a mass average molecular weight of 100,000 to 1,000,000.

Furthermore, in the release sheet according to the present invention, it is also preferred that the diene-based polymer is polybutadiene rubber.

Moreover, in the release sheet according to the present invention, it is also preferred that the release agent layer has an average thickness of 0.02 to 5.0 μm.

In order to achieve the above object, the present invention is also directed to a pressure-sensitive adhesive article including: the release sheet according to the present invention; and a pressure-sensitive adhesive sheet having a pressure-sensitive adhesive layer.

Such a pressure-sensitive adhesive article can sufficiently suppress adverse effects on electric components and the like, and has a small dependence of release force on peel rate.

In the pressure-sensitive adhesive article according to the present invention, it is preferred that the pressure-sensitive adhesive sheet has a label part and an edge part and that when the label part is used, it is peeled off from the release sheet by the hands or a labeling machine after the edge part is peeled off and removed from the release sheet.

Further, in the pressure-sensitive adhesive article according to the present invention, it is also preferred that the pressure-sensitive adhesive layer is mainly constituted of an acrylic pressure-sensitive adhesive.

Furthermore, in the pressure-sensitive adhesive article according to the present invention, it is also preferred that a release force required to peel off the pressure-sensitive adhesive sheet from the release sheet which is measured in an atmosphere of 23° C. and 50% RH at a peel rate of 0.3 m/min and a peel angle of 180° is in the range of 20 to 500 mN/20 mm.

Moreover, in the pressure-sensitive adhesive article according to the present invention, it is also preferred that a release force required to peel off the pressure-sensitive adhesive sheet from the release sheet which is measured in an atmosphere of 23° C. and 50% RH at a peel rate of 30 m/min and a peel angle of 180° is in the range of 100 to 2,500 mN/20 mm.

Moreover, in the pressure-sensitive adhesive article according to the present invention, it is also preferred that when a release force required to peel off the pressure-sensitive adhesive sheet from the release sheet which is measured in an atmosphere of 23° C. and 50% RH at a peel rate of 0.3 m/min and a peel angle of 180° is defined as f₁ (mN/20 mm) and a release force required to peel off the pressure-sensitive adhesive sheet from the release sheet which is measured in an atmosphere of 23° C. and 50% RH at a peel rate of 30 m/min and a peel angle of 180° is defined as f₂ (mN/20 mm), f₁ and f₂ satisfy the following relation: 0.2≦f₂/f₁≦5.

These and other objects, structures and results of the present invention will be apparent more clearly when the following detailed description of the preferred embodiments is considered taken in conjunction with the appended drawings.

### BRIEF DESCRIPTION OF THE DRAWINGS

FIG. 1 is a cross-sectional view of a pressure-sensitive adhesive article according to the present invention.

FIG. 2 is a perspective view of a preferred embodiment of the pressure-sensitive adhesive article according to the present invention.

FIG. 3 is a perspective view which shows a state where an edge part is peeled off and removed from the pressure-sensitive adhesive article shown in FIG. 2.

FIG. 4 is a cross-sectional view of a release sheet according to the present invention.

### DESCRIPTION OF EXEMPLARY EMBODIMENTS

Hereinbelow, the present invention will be described in detail based on preferred embodiments thereof.

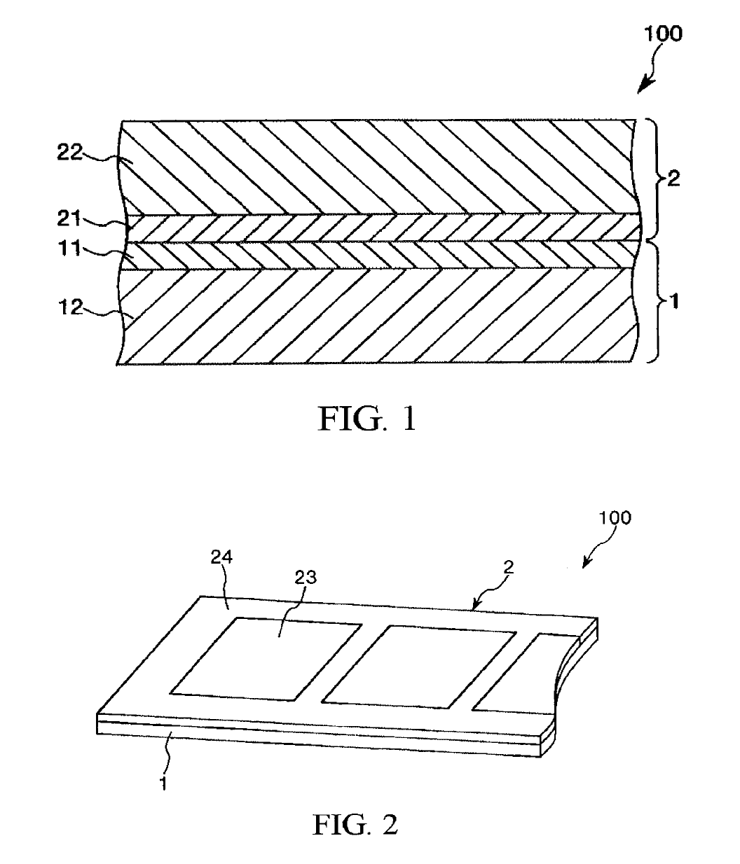

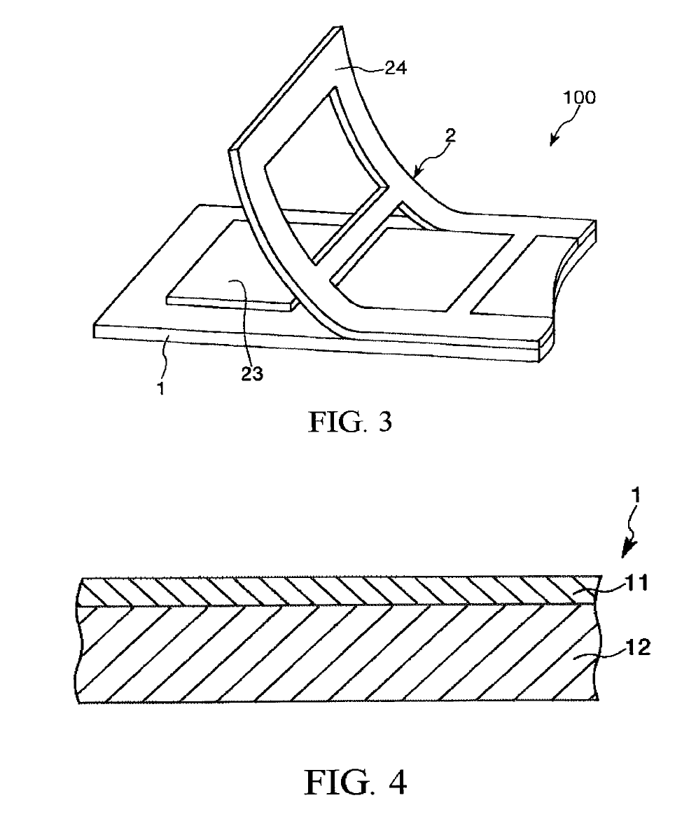

FIG. 1 is a cross-sectional view of a pressure-sensitive adhesive article according to a preferred embodiment of the present invention, FIG. 2 is a perspective view of the pressure-sensitive adhesive article according to the preferred embodiment of the present invention, FIG. 3 is a perspective view which shows a state where an edge part is peeled off and removed from the pressure-sensitive adhesive article shown in FIG. 2, and FIG. 4 is a cross-sectional view of a release sheet according to the present invention. It is to be noted that in the following description, the upper side in FIG. 4 will be referred to as “Upper” or “upper side”. And the lower side in FIG. 4 will be referred to as “lower” or “lower side”.

As shown in FIG. 1, a pressure-sensitive adhesive article 100 (a pressure-sensitive adhesive article according to the present invention) has a structure in which a pressure-sensitive adhesive sheet 2 having a pressure-sensitive adhesive layer 21 and a pressure-sensitive adhesive sheet base 22 adheres to a release sheet 1 having a release agent layer 11 constituted of a material containing substantially no silicone compound (a non-silicone-based release agent) as will be described later and a base material (a release sheet base) 12 so that the pressure-sensitive adhesive layer 21 is in contact with the release agent layer 11.

In the case of such a pressure-sensitive adhesive article 100, the pressure-sensitive adhesive sheet 2 can be peeled off from the release sheet 1.

As shown in FIG. 2, the pressure-sensitive adhesive article 100 according to the present embodiment has a label part 23 and an edge part 24 formed by die cutting or the like.

As shown in FIG. 3, the edge part 24 is peeled off and removed from the pressure-sensitive adhesive article 100 (from the release sheet 1), and the label part 23 is peeled off from the pressure-sensitive adhesive article 100 (from the release sheet 1) and then attached to an adherend by the hands or a labeling machine after the peeling-off and removal of the edge part 24.

Meanwhile, in the case of a conventional pressure-sensitive adhesive article composed of a pressure-sensitive adhesive sheet and a release sheet using a conventional non-silicone-based release agent, a higher release force tends to be required to peel off the pressure-sensitive adhesive sheet from the release sheet at high speed than at low speed.

Particularly, in a case where such a conventional pressure-sensitive adhesive article has a label part and an edge part, and the edge part is first peeled off and removed from the release sheet before the label part is peeled off from the release sheet and attached to an adherend, a high release force is required to peel off and remove the edge part from the release sheet at high speed. This makes it impossible to peel off and remove the edge part from the release sheet at high speed, thereby causing a problem that productivity is lowered. In addition, such an edge part generally has a small width for the purpose of effectively using the pressure-sensitive adhesive sheet, and therefore there is also a problem that the edge part breaks when peeled off from the release sheet at high speed due to a high release force.

Further, a high release force is also required to peel off the label part from the release sheet at high speed, and therefore it is difficult to use a labeling machine which is capable of attaching the label part to an adherend at high speed.

On the other hand, the pressure-sensitive adhesive article according to the present invention has a release sheet according to the present invention as will be described in detail later, and therefore it is possible to reduce the difference between a release force required to peel off a pressure-sensitive adhesive sheet from a release sheet at high speed and a release force required to peel off a pressure-sensitive adhesive sheet from a release sheet at low speed. That is, it is possible to prevent the release force required to peel off the pressure-sensitive adhesive sheet from the release sheet from increasing even when a peel rate is increased and therefore to lessen the dependence of the release force on peel rate. As a result, it is possible to effectively solve the above-described problems.

When a release force required to peel off the pressure-sensitive adhesive sheet 2 from the release sheet 1 of the pressure-sensitive adhesive article 100 which is measured in an atmosphere of 23° C. and 50% RH at a peel rate of 0.3 m/min and a peel angle of 180° is defined as f₁ (mN/20 mm), and a release force required to peel off the pressure-sensitive adhesive sheet 2 from the release sheet 1 of the pressure-sensitive adhesive article 100 which is measured in an atmosphere of 23° C. and 50% RH at a peel rate of 30 m/min and a peel angle of 180° is defined as f₂ (mN/20 mm), f₁ and f₂ preferably satisfy the following relation: 0.2≦f₂/f₁≦5, and more preferably 1≦f₂/f₁≦5. By allowing f₁ and f₂ to satisfy the above relation, it is possible to, for example, effectively prevent the breakage of the pressure-sensitive adhesive sheet 2 (release sheet 1) even when the pressure-sensitive adhesive sheet 2 is peeled off from the release sheet 1 at high peel rate. In addition, it is also possible to use a labeling machine for the pressure-sensitive adhesive article 100.

More specifically, the release force required to peel off the pressure-sensitive adhesive sheet 2 from the release sheet 1 of the pressure-sensitive adhesive article 100 which is measured in the atmosphere of 23° C. and 50% RH at the peel rate of 0.3 m/min and the peel angle of 180° is preferably in the range of 20 to 500 mN/20 mm, more preferably in the range of 30 to 400 mN/20 mm. Such a release force is preferred for low-speed peeling-off.

Further, the release force required to peel off the pressure-sensitive adhesive sheet 2 from the release sheet 1 of the pressure-sensitive adhesive article 100 which is measured in the atmosphere of 23° C. and 50% RH at the peel rate of 30 m/min and the peel angle of 180° is preferably in the range of 100 to 2,500 mN/20 mm, and more preferably in the range of 150 to 2,000 mN/20 mm. This makes it possible to, for example, effectively prevent the breakage of the pressure-sensitive adhesive sheet 2 (release sheet 1) even when the pressure-sensitive adhesive sheet 2 is peeled off from the release sheet 1 at high peel rate. In addition, it is also possible to use the labeling machine for the pressure-sensitive adhesive article 100.

It is to be noted that the release force is measured in the atmosphere of 23° C. and 50% RH by cutting the pressure-sensitive adhesive article to have the width of 20 mm and the length of 200 mm, fixing the release sheet to a tensile tester, and pulling the pressure-sensitive adhesive sheet using the tensile tester at a given peel rate in the 180° direction.

Hereinbelow, a release sheet according to a preferred embodiment of the present invention will be described.

As shown in FIG. 4, a release sheet 1 has a structure in which a release agent layer 11 is formed on a base material 12.

The base material 12 has a function of supporting the release agent layer 11, and is constituted from, for example, a plastic film such as polyester film (e.g., polyethylene terephthalate film, polybutylene terephthalate film, or the like), polyolefin film (e.g., polypropylene film, polymethylpentene film, or the like), polycarbonate film, or the like; a metal foil such as aluminum foil, stainless steel foil, or the like; paper such as glassine paper, woodfree paper, coated paper, impregnated paper, synthetic paper, or the like; or laminated paper obtained by coating such a paper base material with a thermoplastic resin such as polyethylene, or the like.

An average thickness of the base material 12 is not particularly limited, but is preferably in the range of 5 to 300 μm, and more preferably in the range of 10 to 200 μm.

By providing the release agent layer 11 on the base material 12, it is possible to peel off the pressure-sensitive adhesive sheet 2 from the release sheet 1.

The release agent layer 11 is constituted of a material containing substantially no silicone compound to prevent the transfer of a silicone compound from the release sheet to the pressure-sensitive adhesive layer of the pressure-sensitive adhesive article according to the present invention, thereby preventing the release of the silicone compound from the pressure-sensitive adhesive sheet after the pressure-sensitive adhesive sheet is attached to an adherend. Therefore, even when the adherend is electronic equipment such as a relay, the pressure-sensitive adhesive sheet is hard to give adverse effects to the adherend.

It is to be noted that the phrase “containing substantially no silicone compound” means that an amount of the silicone compound measured by X-ray photoelectron spectroscopy (XPS) is preferably 0.5 atomic % or less, and more preferably 0.1 atomic % or less. The measurement conditions of X-ray photoelectron spectroscopy (XPS) are as follows, and the amount of the silicone compound is calculated in the following manner using measured values.

Measurement instrument: Quantera SXM manufactured by ULVAC-PHI, INC.

X-ray: AlKα (1486.6 eV)

Takeoff angle: 45°

Elements measured: silicon (Si) and carbon (C)

The amount of a silicone compound is expressed in “atomic %” calculated by multiplying the value of Si/(Si+C) by 100.

As described above, in the case of a conventional pressure-sensitive adhesive article composed of a pressure-sensitive adhesive sheet and a release sheet using a conventional non-silicone-based release agent, a higher release force tends to be required to peel off the pressure-sensitive adhesive sheet from the release sheet at high speed than at low speed, which is a cause of the above-described various problems.

In order to solve the problems, the present inventors have intensively studied, and as a result have found that by using a release sheet having a release agent layer formed by curing a release agent mainly constituted of a diene-based polymer whose Mooney viscosity (ML₁₊₄ (100° C.)) measured before curing according to JIS K6300 at a temperature of 100° C. is in the range of 40 to 70, it is possible to reduce the difference between a release force required to peel off a pressure-sensitive adhesive sheet from the release sheet at high speed and a release force required to peel off a pressure-sensitive adhesive sheet from the release sheet at low speed, that is, it is possible to prevent an increase in release force required to peel off a pressure-sensitive adhesive sheet from a release sheet even when a peel rate is increased and therefore to lessen the dependence of the release force on the peel rate. Further, the present inventors have also found that by using such a release sheet, it is possible to effectively solve the above-described various problems.

As described above, the release sheet according to the present invention is characterized in that it has the release agent layer formed by curing the release agent mainly constituted of the diene-based polymer and that Mooney viscosity (ML₁₊₄ (100° C.)) of the diene-based polymer before curing which is measured according to JIS K6300 at the temperature of 100° C. is in the range of 40 to 70. These two features make it possible to obtain the above-described excellent effects of the present invention. However, these effects of the present invention cannot be obtained only by satisfying one of the two features.

As described above, the Mooney viscosity (ML₁₊₄ (100° C.)) of the diene-based polymer before curing is in the range of 40 to 70, but is preferably in the range of 40 to 60, and more preferably in the range of 40 to 50. By setting the Mooney viscosity to a value within the above range, the effects of the present invention become more conspicuous.

Examples of the diene-based polymer for use in forming the release agent layer 11 include polybutadiene rubber, polyisoprene rubber, styrene-butadiene rubber, styrene-isoprene rubber, and the like. Among these diene-based polymers, polybutadiene rubber (especially, 1,4-polybutadiene rubber) is particularly preferred. By using such a diene-based polymer, it is possible to provide the release sheet which is hard to give adverse effects to electric components such as relays, various switches, connectors, and motors and which has a smaller dependence of the release force on the peel rate.

Further, it is preferred that the release agent (material before curing) which is used in forming the release agent layer 11 is mainly constituted of one or two or more diene-based polymers having a cis-1,4 bond content of 90 to 99%. This makes it possible to easily obtain a favorable Mooney viscosity, thereby further lessening the dependence of the release force on the peel rate.

A mass average molecular weight of the diene-based polymer before curing is preferably in the range of 100,000 to 1,000,000, and more preferably in the range of 150,000 to 500,000. This makes it possible to easily obtain the favorable Mooney viscosity, thereby further lessening the dependence of the release force on the peel rate.

An average thickness of the release agent layer 11 is not particularly limited, but is preferably in the range of 0.02 to 5.0 μm, more preferably in the range of 0.03 to 3.0 μm, and even more preferably in the range of 0.05 to 1.0 μm. If the average thickness of the release agent layer 11 is less than the above lower limit value, there is a case where releasability of the pressure-sensitive adhesive sheet 2 from the release sheet 1 is poor. On the other hand, if the average thickness of the release agent layer 11 exceeds the above upper limit value, there is a case where blocking is likely to occur between the release agent layer 11 and the back surface of the release sheet 1 when the release sheet 1 is wound up in a rolled form so that the releasability of the release agent layer 11 is deteriorated due to blocking.

Examples of a method for curing the uncured release agent described above include, but are not limited to, irradiation with active energy rays such as UV rays, heating, and the like.

The release agent layer 11 may further contain another resin component and/or various additives such as plasticizers, stabilizers, crosslinking agents, sensitizers, and radical initiators. Further, a primer layer may be provided between the release agent layer 11 and the base material 12 for the purpose of improving adhesion between them.

Hereinbelow, the pressure-sensitive adhesive sheet will be described.

As shown in FIG. 1, the pressure-sensitive adhesive sheet 2 has a structure in which the pressure-sensitive adhesive layer 21 is formed on the pressure-sensitive adhesive sheet base 22.

The pressure-sensitive adhesive sheet base 22 has the function of supporting the pressure-sensitive adhesive layer 21, and is constituted from, for example, a plastic film such as polyethylene terephthalate film, polybutylene terephthalate film, polyethylene film, polypropylene film, polymethylpentene film, polycarbonate film, or the like; a metal foil such as aluminum foil, stainless steel foil, or the like; paper such as lint-free paper, synthetic paper, or the like; or a laminate body of two or more of them.

Among them, the pressure-sensitive adhesive sheet base 22 is particularly preferably constituted from a plastic film such as polyester film (e.g., polyethylene terephthalate film or polybutylene terephthalate film) or polypropylene film, or so-called lint-free paper from which less dust particles are generated (see, for example, JP-B-6-11959). When the pressure-sensitive adhesive sheet base 22 is constituted from the plastic film or the lint-free paper, dust particles and the like are less likely to be generated when the pressure-sensitive adhesive sheet 2 is manufactured and used so that electronic components such as relays are less likely to be adversely affected. In addition, when the pressure-sensitive adhesive sheet base 22 is constituted from the plastic film or the lint-free paper, the pressure-sensitive adhesive sheet 2 can be easily formed into a desired shape by cutting or die cutting. Further, in a case where the plastic film is used as the pressure-sensitive adhesive sheet base 22, the polyethylene terephthalate film is particularly preferable as the polyethylene terephthalate film because the polyethylene terephthalate film has the advantages that generation of the dust particles is low and that generation of gas during heating is low.

An average thickness of the pressure-sensitive adhesive sheet base 22 is not particularly limited, but is preferably in the range of 5 to 300 μm, and more preferably in the range of 10 to 200 μm.

Printing or typing may be applied to the surface of the pressure-sensitive adhesive sheet base 22 (i.e., to the surface opposite to the surface on which the pressure-sensitive adhesive layer 21 is to be laminated). Further, surface treatment may be made to the surface of the pressure-sensitive adhesive sheet base 22 for the purpose of, for example, improving adhesion of printing or typing to the surface of the pressure-sensitive adhesive sheet base 22. Further, the pressure-sensitive adhesive sheet 2 may also serve as a label.

The pressure-sensitive adhesive layer 21 is constituted of a pressure-sensitive adhesive composition mainly containing a pressure-sensitive adhesive.

Examples of the pressure-sensitive adhesive include acrylic pressure-sensitive adhesives, polyester-based pressure-sensitive adhesives, and urethane-based pressure-sensitive adhesives.

For example, in a case where acrylic pressure-sensitive adhesives are used as the pressure-sensitive adhesive, the acrylic pressure-sensitive adhesives can be constituted of a polymer or a copolymer mainly containing a main monomer component for imparting tackiness, a comonomer component for imparting adhesiveness or cohesive force, and a functional group-containing monomer component for improving crosslinking site or adhesiveness.

Examples of the main monomer component include: acrylic alkyl esters such as ethyl acrylate, butyl acrylate, amyl acrylate, 2-ethylhexyl acrylate, octyl acrylate, cyclohexyl acrylate, benzyl acrylate, methoxyethyl acrylate, and the like; and methacrylic alkyl esters such as butyl methacrylate, 2-ethylhexyl methacrylate, cyclohexyl methacrylate, benzyl methacrylate, and the like.

Examples of the comonomer component include methyl acrylate, methyl methacrylate, ethyl methacrylate, vinyl acetate, styrene, and acrylonitrile.

Examples of the functional group-containing monomer component include: carboxyl group-containing monomers such as acrylic acid, methacrylic acid, maleic acid, and itaconic acid; hydroxyl group-containing monomers such as 2-hydroxyethyl acrylate, hydroxyethyl methacrylate, 2-hydroxypropyl acrylate, 2-hydroxypropyl methacrylate, N-methylolacrylamide, and the like; acrylamide; methacrylamide; glycidyl methacrylate; and the like.

By containing these components, tackiness and cohesive force of the pressure-sensitive adhesive composition are improved. Further, such acrylic pressure-sensitive adhesives usually have no unsaturated bond in its molecule, and therefore the pressure-sensitive adhesive composition containing the acrylic pressure-sensitive adhesives has improved stability with respect to light or oxygen. Further, by appropriately selecting the kind of monomer or the molecular weight of the pressure-sensitive adhesive, it is possible to obtain a pressure-sensitive adhesive composition having quality and properties suitable for its purpose of use.

The pressure-sensitive adhesive composition may be either of a crosslinked type to which crosslinking treatment has been carried out or a non-crosslinked type to which crosslinking treatment has not been carried out. However, the crosslinked type is preferably used. By using the crosslinked type pressure-sensitive adhesive composition, it is possible to form the pressure-sensitive adhesive layer 21 having further excellent cohesive force.

Examples of a crosslinking agent to be used for the crosslinked type pressure-sensitive adhesive composition include epoxy compounds, isocyanate compounds, metal chelate compounds, metal alkoxides, metal salts, amine compounds, hydrazine compounds, aldehyde compounds, and the like.

If necessary, the pressure-sensitive adhesive composition to be used in the present invention may contain various additives such as plasticizers, tackifiers, stabilizers, and the like.

An average thickness of the pressure-sensitive adhesive layer 21 is not particularly limited, but is preferably in the range of 5 to 200 μm, and more preferably in the range of 10 to 100 μm.

Hereinbelow, one example of a method for producing a pressure-sensitive adhesive article 100 will be described.

First, one example of a method for producing a release sheet 1 constituting the pressure-sensitive adhesive article 100 will be described.

First, a base material 12 is prepared, and a release agent is supplied onto the base material 12. Then, the release agent is irradiated with active energy rays such as UV rays or heated to form a release agent layer 11. In this way, the release sheet 1 is produced.

Examples of a method for supplying the release agent onto the base material 12 include various conventional methods such as a gravure coating method, a bar coating method, a spray coating method, a spin coating method, a knife coating method, a roll coating method, a die coating method, and the like.

Hereinbelow, one example of a method for producing a pressure-sensitive adhesive sheet 2 constituting the pressure-sensitive adhesive article 100 will be described.

First, a pressure-sensitive adhesive sheet base 22 is prepared, and then a pressure-sensitive adhesive composition is supplied onto the pressure-sensitive adhesive sheet base 22 to form a pressure-sensitive adhesive layer 21. In this way, the pressure-sensitive adhesive sheet 2 is produced.

Examples of a method for supplying a pressure-sensitive adhesive composition onto a pressure-sensitive adhesive sheet base 22 include various conventional methods such as a gravure coating method, a bar coating method, a spray coating method, a spin coating method, a knife coating method, a roll coating method, a die coating method, and the like.

In this case, the pressure-sensitive adhesive composition may be of a solvent type, an emulsion type, a hot-melt type, or the like.

Then, the thus obtained pressure-sensitive adhesive sheet 2 and release sheet 1 are laminated together so that the pressure-sensitive adhesive layer 21 and the release agent layer 11 are in contact with each other, thereby enabling a pressure-sensitive adhesive article 100 to be obtained.

Alternatively, the pressure-sensitive adhesive article 100 may be produced by forming the pressure-sensitive adhesive layer 21 on the release agent layer 11 of the release sheet 1, and then laminating the pressure-sensitive adhesive sheet base 22 on the pressure-sensitive adhesive layer 21.

Although the release sheet and the pressure-sensitive adhesive article according to the present invention have been described with reference to the preferred embodiments thereof, the present invention is not limited thereto. For example, the pressure-sensitive adhesive article according to the present invention may have a structure such that two pressure-sensitive adhesive layers are formed on both surfaces of the pressure-sensitive adhesive sheet base and release sheets are respectively attached to surfaces of each of the pressure-sensitive adhesive layers.

Further, although the release sheet according to the above embodiment is constituted from the release agent layer and the base material, the release agent layer may also have a function of the base material as a resin film.

Furthermore, although the pressure-sensitive adhesive article according to the above embodiment has a structure such that the pressure-sensitive adhesive sheet is laminated on the release sheet, the pressure-sensitive adhesive article according to the present invention may have a structure such that a release agent layer is formed on one surface of a base material and a pressure-sensitive adhesive layer is formed on the other surface of the base material.

The applications of the release sheet and the pressure-sensitive adhesive article according to the present invention are not limited to the above-mentioned electric components such as relays, various switches, connectors, motors, hard disk drives, and the like.

### EXAMPLES

Hereinbelow, actual examples of the pressure-sensitive adhesive article according to the present invention will be described.

### 1. Preparation of Release Agent

(Preparation of Release Agent A)

5.4 kg of 1,3-butadiene was placed in a 20-L autoclave equipped at the top with a reflux condenser cooled with liquid ammonium.

On the other hand, 1.2 mmol of nickel naphthenate, 7.3 mmol of boron trifluoride etherate, and 6.6 mmol of n-butyl lithium were dissolved in this order in 250 mL of toluene, from which moisture had been removed, to prepare a toluene solution.

This toluene solution was fed into the autoclave to initiate a polymerization reaction.

The polymerization reaction was initiated at 30° C.

After a lapse of 30 minutes, 50 mL of isopropyl alcohol was added to terminate the reaction. The reaction was terminated at 50° C.

Then, the inner pressure of the autoclave was reduced to atmospheric pressure, and a residual monomer was removed by flashing. Then, a reaction product was dried to obtain a release agent A (1,4-polybutadiene rubber).

The Mooney viscosity (ML₁₊₄ (100° C.)) of the release agent A was 44. A mass average molecular weight of the release agent A was 360,000. The cis-1,4 bond content of the release agent A was 96.0%. It is to be noted that the cis-1,4 bond content was measured by infrared absorption spectroscopy (ATR method).

(Preparation of Release Agent B)

A release agent B was prepared in the same manner as in the case of the preparation of the release agent A except that n-butyl lithium was replaced with triethylaluminum and that the time interval from initiation to termination of the reaction was changed to 20 minutes.

The Mooney viscosity (ML₁₊₄ (100° C.)) of the release agent B was 43. A mass average molecular weight of the release agent B was 240,000. The cis-1,4 bond content of the release agent B was 97.0%. It is to be noted that the cis-1,4 bond content was measured by infrared absorption spectroscopy (ATR method).

### 2. Preparation of Pressure-Sensitive Adhesive

(Pressure-Sensitive Adhesive A)

0.1 part by weight of a metal chelate compound (manufactured by Kawaken Fine Chemicals Co., Ltd. under the trade name of “Aluminum Chelate D”) was added as a crosslinking agent with respect to 100 parts by weight of a toluene solution (solid content: about 30 wt %) of an acrylic ester copolymer (composition: 2-ethylhexyl acrylate/butyl acrylate/vinyl acetate/acrylic acid=55/20/23/2 (wt %), mass average molecular weight: about 500,000) to prepare a pressure-sensitive adhesive A.

(Pressure-Sensitive Adhesive B)

7 parts by weight of a polyisocyanate compound (manufactured by TOYO INK MFG. Co., Ltd. under the trade name of “BHS-8515”) was added as a crosslinking agent with respect to 100 parts by weight of a toluene solution (solid content: about 30 wt %) of an acrylic ester copolymer (composition: 2-ethylhexyl acrylate/butyl acrylate/2-hydroxyethyl acrylate=60/39/1 (wt %), mass average molecular weight: about 700,000) to prepare a pressure-sensitive adhesive B.

### 3. Production of Pressure-Sensitive Adhesive Article

### Example 1

### (1) Production of Release Sheet

First, the release agent A was diluted with toluene to prepare a dispersion liquid having a solid content of 1.0 wt %.

The thus obtained dispersion liquid was supplied onto one surface of a polyethylene terephthalate (PET) film having an average thickness of 38 μm (manufactured by Mitsubishi Polyester Film Corporation under the trade name of “PET38T-100”) using a Mayer bar #4, and was dried by heating at 100° C. for 60 seconds and irradiated with UV rays at 100 mJ/cm² to form a release agent layer having an average thickness of 0.1 μm. In this way, a release sheet was produced.

### (2) Production of Pressure-Sensitive Adhesive Sheet

The pressure-sensitive adhesive A was supplied onto one surface of a PET film having an average thickness of 50 μm (manufactured by Mitsubishi Polyester Film Corporation under the trade name of “PET50T-100”) using an applicator, and was then dried by heating at 120° C. for 60 seconds to form a pressure-sensitive adhesive layer having a thickness of 25 μm. In this way, a pressure-sensitive adhesive sheet was produced.

### (3) Production of Pressure-Sensitive Adhesive Article

The thus obtained release sheet and pressure-sensitive adhesive sheet were laminated together so that the release agent layer and the pressure-sensitive adhesive layer were in contact with each other to obtain a pressure-sensitive adhesive article.

### Example 2

A pressure-sensitive adhesive article was produced in the same manner as in the Example 1 except that the pressure-sensitive adhesive A used for producing a pressure-sensitive adhesive sheet was replaced with the pressure-sensitive adhesive B.

### Example 3

A pressure-sensitive adhesive article was produced in the same manner as in the Example 1 except that the release agent A used for producing a release sheet was replaced with the release agent B.

### Example 4

A pressure-sensitive adhesive article was produced in the same manner as in the Example 3 except that the pressure-sensitive adhesive A used for producing a pressure-sensitive adhesive sheet was replaced with the pressure-sensitive adhesive B.

### Comparative Example 1

A pressure-sensitive adhesive article was produced in the same manner as in the Example 1 except that the release agent A used for producing a release sheet was replaced with 1,4-polybutadiene rubber (manufactured by ZEON Corporation under the trade name of “BR1241”) as a diene-based polymer. It is to be noted that the 1,4-polybutadiene rubber used had a mass average molecular weight of 210,000, a Mooney viscosity (ML₁₊₄ (100° C.)) of 35, and a cis-1,4 bond content of 36.5%.

### Comparative Example 2

A pressure-sensitive adhesive article was produced in the same manner as in the Comparative Example 1 except that the pressure-sensitive adhesive A used for producing a pressure-sensitive adhesive sheet was replaced with the pressure-sensitive adhesive B.

### Comparative Example 3

A pressure-sensitive adhesive article was produced in the same manner as in the Example 1 except that the release agent A used for producing a release sheet was replaced with 1,4-polybutadiene rubber (manufactured by KURARAY Co., Ltd. under the trade name of “LIR-300”) as a diene-based polymer. It is to be noted that the 1,4-polybutadiene rubber used had a mass average molecular weight of 35,000 and a cis-1,4 bond content of 50.0%. The Mooney viscosity (ML₁₊₄ (100° C.)) of the 1,4-polybutadiene rubber could not be measured.

### Comparative Example 4

A pressure-sensitive adhesive article was produced in the same manner as in the Comparative Example 3 except that the pressure-sensitive adhesive A used for producing a pressure-sensitive adhesive sheet was replaced with the pressure-sensitive adhesive B.

### Comparative Example 5

A pressure-sensitive adhesive article was produced in the same manner as in the Example 1 except that the release agent A used for producing a release sheet was replaced with 1,4-polybutadiene rubber (manufactured by JSR Corporation under the trade name of “BR-10”) as a diene-based polymer. It is to be noted that the 1,4-polybutadiene rubber used had a mass average molecular weight of 420,000, a Mooney viscosity (ML₁₊₄ (100° C.)) of 28, and a cis-1,4 bond content of 95.0%.

### Comparative Example 6

The pressure-sensitive adhesive article was produced in the same manner as in the Comparative Example 5 except that the pressure-sensitive adhesive A used for producing a pressure-sensitive adhesive sheet was replaced with the pressure-sensitive adhesive B.

The mass average molecular weights, Mooney viscosities, cis-1,4 bond contents, and silicone compound contents of the uncured release agents used for producing the pressure-sensitive adhesive articles of the Examples 1 to 4 and the Comparative Examples 1 to 6 are shown in Table 1.

### Table 1

### 4. Evaluation

(Release Force Test)

For each of the pressure-sensitive adhesive articles of the Examples 1 to 4 and the Comparative Examples 1 to 6, a release force was measured. It is to be noted that the release force was measured after the pressure-sensitive adhesive articles were left stand in an atmosphere of 23° C. and 50% RH for 1 day.

The release force was measured in an atmosphere of 23° C. and 50% RH by cutting the pressure-sensitive adhesive article to have the width of 20 mm and the length of 200 mm, fixing the release sheet to a tensile tester, and pulling the pressure-sensitive adhesive sheets using the tensile tester at a predetermined peel rate in the 180° direction. In this release force test, a release force at a peel rate of 0.3 m/min and a release force at a peel rate of 30 m/min were measured, and they were defined as f₁ and f₂, respectively.

It is to be noted that, in the cases of the pressure-sensitive adhesive articles of the Comparative Examples 3 and 4, the pressure-sensitive adhesive sheet could not be peeled off from the release sheet, and therefore a release force could not be measured.

For the Examples 1 to 4 and the Comparative Examples 1 to 6, the release forces f₁, the release forces f₂, and the values of f₂/f₁ are shown in Table 1.

As can be seen from Table 1, the pressure-sensitive adhesive articles of the Examples 1 to 4 (release sheets and pressure-sensitive adhesive articles according to the present invention) had a small dependence of release force on peel rate. On the other hand, in the cases of the pressure-sensitive adhesive articles of the Comparative Examples 1 to 6, satisfactory results could not be obtained. Further, the release sheets (pressure-sensitive adhesive articles) according to the present invention did not contain a silicone compound. This indicated that the release sheets (pressure-sensitive adhesive articles) according to the present invention were hard to give adverse effects to electric components such as relays.

### INDUSTRIAL APPLICABILITY

According to the present invention, it is possible to provide a release sheet which can sufficiently suppress adverse effects on electric components such as relays, various switches, connectors, motors, and hard disk drives and which has a small dependence of release force on peel rate, and a pressure-sensitive adhesive article having such a release sheet. Therefore, the present invention has industrial applicability.

What is claimed is:

1. A pressure-sensitive adhesive article, comprising:
a release sheet; and
a pressure-sensitive adhesive sheet having a pressure-sensitive adhesive layer which adheres to the release sheet,
wherein the release sheet including
a base material; and
a release agent layer provided on the base material,
wherein the release agent layer is formed by curing a material mainly constituted of a diene-based polymer, and the release agent layer contains substantially no silicone compound, and wherein Mooney viscosity (ML₁₊₄ (100° C.)) of the diene-based polymer before curing which is measured according to JIS K6300 at a temperature of 100° C. is in the range of 40 to 70,
wherein the diene-based polymer before curing has a mass average molecular weight of 150,000 to 500,000.

2. The pressure-sensitive adhesive article as claimed in claim 1, wherein the pressure-sensitive adhesive sheet has a label part and an edge part, and wherein when the label part is used, it is peeled off from the release sheet by the hands or a labeling machine after the edge part is peeled off and removed from the release sheet.

3. The pressure-sensitive adhesive article as claimed in claim 1, wherein the pressure-sensitive adhesive layer is mainly constituted of an acrylic pressure-sensitive adhesive.

4. The pressure-sensitive adhesive article as claimed in claim 1, wherein a release force required to peel off the pressure-sensitive adhesive sheet from the release sheet which is measured in an atmosphere of 23° C. and 50% RH at a peel rate of 0.3 m/min and a peel angle of 180° is in the range of 20 to 500 mN/20 mm.

5. The pressure-sensitive adhesive article as claimed in claim 1, wherein a release force required to peel off the pressure-sensitive adhesive sheet from the release sheet which is measured in an atmosphere of 23° C. and 50% RH at a peel rate of 30 m/min and a peel angle of 180° is in the range of 100 to 2,500 mN/20 mm.

6. The pressure-sensitive adhesive article as claimed in claim 1, wherein when a release force required to peel off the pressure-sensitive adhesive sheet from the release sheet which is measured in an atmosphere of 23° C. and 50% RH at a peel rate of 0.3 m/min and a peel angle of 180° is defined as f₁ (mN/20 mm) and a release force required to peel off the pressure-sensitive adhesive sheet from the release sheet which is measured in an atmosphere of 23° C. and 50% RH at a peel rate of 30 m/min and a peel angle of 180° is defined as f₂ (mN/20 mm), f₁ and f₂ satisfy the following relation: 0.2≦f₂/f₁≦5.

7. The pressure-sensitive adhesive article as claimed in claim 1, wherein the material before curing is mainly constituted of one or two or more diene-based polymers having a cis-1,4 bond content of 90 to 99%.

8. The pressure-sensitive adhesive article as claimed in claim 1, wherein the diene-based polymer is polybutadiene rubber.

9. The pressure-sensitive adhesive article as claimed in claim 1, wherein the release agent layer has an average thickness of 0.02 to 5.0 μm.
